(19) United States
(12) Patent Application Publication
(10) Pub. No.: US 2025/0306902 A1
(43) Pub. Date: Oct. 2, 2025

(54) FIRMWARE UPDATE METHOD AND DISPLAY DEVICE

(71) Applicant: Lenovo (Beijing) Limited, Beijing (CN)

(72) Inventors: Shuang HAN, Beijing (CN); Zhiyong LU, Beijing (CN)

(21) Appl. No.: 19/074,372

(22) Filed: Mar. 8, 2025

(30) Foreign Application Priority Data
Mar. 29, 2024 (CN) 202410381946.0

(51) Int. Cl. G06F 8/65

(52) U.S. Cl. CPC G06F 8/65

(57) ABSTRACT

A firmware update method includes, in response to obtaining, by a first display device through a video interface with a second display device, a target firmware update package provided by a host device, establishing a target path to a target component based on the target firmware update package, to enable the target component to complete a firmware update operation based on the target path. The second display device is directly connected in series to the host device through the video interface or through an interface other than the video interface, or the second display device is connected in series to the host device through at least one third display device.

### CROSS-REFERENCE TO RELATED APPLICATION

This application claims priority to Chinese Patent Application No. 202410381946.0, filed on Mar. 29, 2024, the entire content of which is incorporated herein by reference.

### TECHNICAL FIELD

The present disclosure generally relates to the field of firmware upgrade technologies and, more particularly, to a firmware update method and a display device.

### BACKGROUND

Currently, there are many scenarios where multiple monitors are daisy-chained, and these monitors are usually connected by only one cable for transmitting image signals. When the firmware of these monitors needs to be upgraded, it is needed to connect a USB data cable to each monitor and transmit the upgrade data to the monitor through the USB data cable to complete the firmware upgrade. However, the above implementation is very cumbersome and time-consuming for scenarios with many monitors.

### SUMMARY

In accordance with the disclosure, there is provided a firmware update method including in response to obtaining, by a first display device through a video interface with a second display device, a target firmware update package provided by a host device, establishing a target path to a target component based on the target firmware update package, to enable the target component to complete a firmware update operation based on the target path. The second display device is directly connected in series to the host device through the video interface or through an interface other than the video interface, or the second display device is connected in series to the host device through at least one third display device.

Also in accordance with the disclosure, there is provided a first display device including a video interface configured to be connected in series to a second display device to obtain, through the second display device, a target firmware update package provided by a host device, and a functional component connected to the video interface and configured to establish a target path to a target component based on the target firmware update package, to enable the target component to complete a firmware update operation based on the target path. The second display device is directly connected in series to the host device through the video interface or through an interface other than the video interface, or the second display device is connected in series to the host device through at least one third display device.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

FIG. 1 is a flowchart of a firmware update method consistent with embodiments of the present disclosure.

FIG. 2 is a flowchart showing establishing a target path consistent with embodiments of the present disclosure.

FIG. 3 is a schematic diagram showing a connection of functional components of a first display device consistent with embodiments of the present disclosure.

FIG. 4 is another schematic diagram showing a connection of functional components of a first display device consistent with embodiments of the present disclosure.

FIG. 5 is another schematic diagram showing a connection of functional components of a first display device consistent with embodiments of the present disclosure.

FIG. 6 is a schematic structural diagram of a display device consistent with embodiments of the present disclosure.

### DETAILED DESCRIPTION OF THE EMBODIMENTS

Embodiments of the present disclosure will be described below in connection with the drawings. Obviously, the described embodiments are only part of the embodiments of the present disclosure, but not all of the embodiments. Based on the embodiments described in the present disclosure, all other embodiments obtained by those skilled in the art without making creative work are within the scope of the present disclosure.

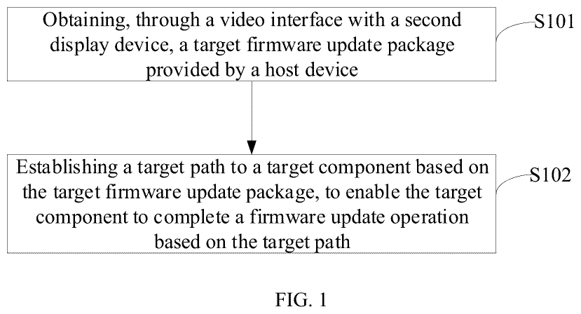

The present disclosure provides a firmware update method. FIG. 1 is a flowchart of a firmware update method consistent with the present disclosure. The method may be applied to a first display device, and the first display device may be a display device in a combination of multiple display devices connected in series in a daisy-chain manner, and this display device may be connected to other display devices through video interfaces. For example, the first display device may be a second monitor or any subsequent monitor in the daisy-chain display device combination. In the daisy-chain display device combination, multiple display devices may be connected in series in sequence, and usually, a display device at the first position in the daisy-chain display device may be connected to a host device, such as a laptop, a tablet computer, an all-in-one machine, a PC host, a server, a mobile phone, etc. The host device may send communication data to the display device at the first position in the daisy-chain display device combination, and at least part of the communication data may be transmitted in sequence in the subsequent display devices connected in series.

The method includes:
S101: obtaining, through a video interface with a second display device, a target firmware update package provided by the host device; and
S102: establishing a target path to a target component based on the target firmware update package, to enable the target component to complete the firmware update operation based on the target path.

The video interface may be any one of a DP (DisplayPort) interface, an HDMI (High Definition Multimedia Interface) interface, a VGA (Video Graphic Array) interface, or a DVI (Digital Visual Interface) interface, or may also be an interface of other video interface standards that may appear at present or in the future, and the present disclosure does not limit this.

The target component may or may not belong to the first display device. In one embodiment, the first display device may receive the target firmware update package from the video interface through a first functional component. The first functional component may be a display controller, such as a Scalar chip, which may determine the target component based on firmware-related information corresponding to the target firmware update package. The first functional component may also be other functional components, such as a USB HUB, and the present disclosure does not limit the first functional component connected to the video interface. In addition to the Scalar chip itself, the components with firmware in the display device may also include but are not limited to a USB HUB or a PD controller (power supply control chip). Therefore, in actual applications, the target path between the target component may be but is not limited to a data burning path from the Scalar to the USB HUB and/or the PD controller. In addition to the USB HUB and PD controller of the first display device itself, the target firmware update package may also include firmware update data of other display devices connected to the first display device. Therefore, in addition to the aforementioned scalar, USB HUB, and PD controller, the target component may also include the Scalar, the USB HUB, and the PD controller of other display devices connected to the first display device. When the firmware update package is a firmware update package for one display device connected to the first display device, the Scalar of the first display device may need to establish the target path to the Scalar of the next display device, and the Scalar of the next display device may also establish the target path it needs to establish based on the content of the firmware update package. That is, the target path may be the path from the Scalar/USB Hub (or USB Controller) of the first display device to the target component (such as Scalar, USB controller, or PD controller) of the next display device.

Different firmware update packages may correspond to different target paths. For example, when the firmware update package is a firmware update package of the USB HUB (or the USB controller) of the first display device, the target path may be the path from the Scalar of the first display device to the USB HUB. When the firmware update package is a firmware update package of one display device connected downstream of the first display device, the target path may be the path from the Scalar of the first display device to the Scalar of the display device connected downstream. After receiving the firmware update package belonging to itself, the target component may directly burn the firmware update package to its corresponding storage area to complete the firmware update.

The second display device may be directly connected in series to the host device through a first interface, and the first interface may be the same as or different from the video interface. In another embodiment, the second display device may be connected in series to the host device through at least one third display device. A display device directly connected to the host device is also referred to as a “direct-connection display device.” A display device connected to the host device through at least one other display device is also referred to as an “indirect-connection display device.” The first display device may be a direct-connection display device or an indirect-connection display device.

In the embodiments of the present disclosure, the second display device may be directly connected to the first display device through a video interface. The second display device may be any display device in the daisy chain display device combination. When the second display device is directly connected in series to the host device, it may be a display device in the daisy chain display device combination at the first position, and the first interface between the second display device and the host device may be but is not limited to a USB interface, a DP interface, an HDMI interface, etc. When the second device is connected in series to the host device through the at least one third display device, there may be at least one other display device between the second display device and the host device, that is, the at least one third display device. In this case, the second display device may not be the display device at the first position in the daisy chain, and may be the display device at the second position, the display device at the third position, etc.

The firmware update method provided by the present disclosure may be applied to at least some display devices in the daisy-chain display device combination. When the firmware of multiple display devices in the daisy-chain display device combination is updated, there may be no need to establish a data transmission path for each display device for sending the firmware update package. The firmware update packages of all display devices may be transmitted by the host device through the video interface between the relevant display devices in the daisy chain, and each display device may establish one target path with the target component based on the target firmware update package to transmit the target firmware update package, such that the target component completes the firmware update. The firmware update of the daisy-chain display device combination using the method provided by the present disclosure may be simple and efficient, and the firmware update may be completed imperceptibly without the need for the user to manually connect the USB cable, thereby improving the user experience.

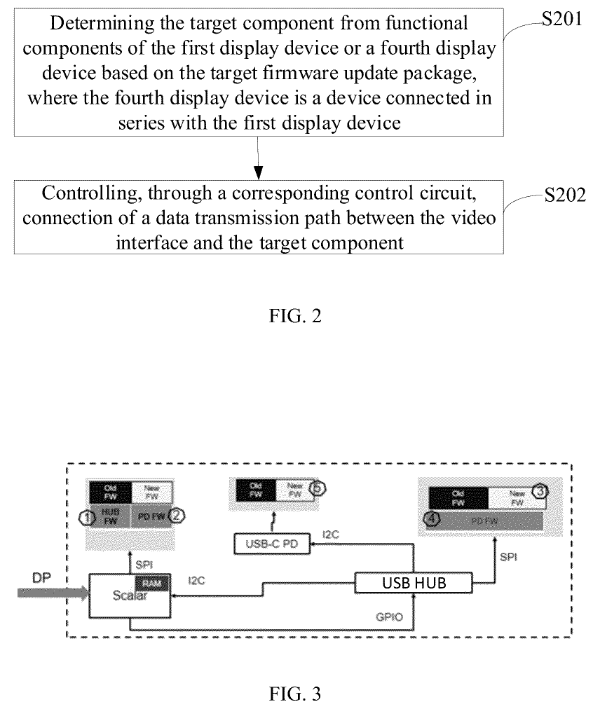

FIG. 2 is a flowchart showing establishing of the target path. Establishing the target path to the target component based on the target firmware update package includes S201 and S202.

At S201, the target component is determined from the functional components of the first display device or a fourth display device based on the target firmware update package, where the fourth display device is a device connected in series to the first display device.

Since the target firmware update package is sent by the host device, it may only be transmitted backward through each display device connected in series in the daisy chain, and the firmware update package of the display device at the back of the daisy chain may need to be transmitted through the display devices at the front of the daisy chain. Therefore, the target firmware update package may include the firmware update package of the current display device, that is, the firmware update package of the first display device, and may also include the firmware update package of other display devices connected downstream of the first display device. Therefore, the target component corresponding to the target firmware update package may be a functional component in the first display device, or a functional component in the display device connected downstream of the first display device.

At S202, connection of a data transmission path between the video interface and the target component is controlled through a corresponding control circuit.

The first display device may include multiple functional components, and different functional components may be connected through some lines (signal paths) which may be used to transmit indication signals, data content, or the above two different types of data. After the target component is determined, the corresponding control circuit in the first display device may control the signal path between the video interface and the target component to form the corresponding data transmission path, such that the target firmware update package is able to be transmitted to the target component through the connected data transmission path, and then the target component may burn the corresponding content in the target firmware update package to the firmware storage area to complete the firmware update by loading and running the corresponding firmware update data after performing a restart or initialization operation.

The control circuit may be a signal path between functional components, or may include a signal path between a first functional component and the target component through a control switch such as a mux, such as a signal path between Scalar and USB hub, or a signal path between USB Hub and Scalar or PD controller.

Determining the target component from the functional components of the first display device or the fourth display device based on the target firmware update package may have different implementations, and several of them will be schematically introduced below.

In one embodiment, determining the target component from functional components of the first display device or the fourth display device based on the target firmware update package may include: obtaining attribute information of the target firmware update package, and determining a component among the functional components of the first display device or the fourth display device that matches the attribute information as the target component.

The attribute information may include, but is not limited to, attribute identification, attribute description information, encryption information, etc. The role of the attribute information may at least include determining the firmware update object or obtaining available firmware update data. For example, the attribute identification and attribute description information may record the display device name and the functional component name, or the attribute identification may be able to locate and match a functional component of a certain display device, such that the target component corresponding to the target firmware update package may be determined based on the attribute identification and attribute description information, that is, which functional component in which display device the target firmware update package belongs to may be determined. Also, the target firmware update package may include encryption information. The electronic device may obtain the encryption information after obtaining the target firmware update, and then the encryption information may be compared with the encryption information of the current firmware data of the current functional component. When the comparison result is consistent, it may be determined that the target firmware update package is for updating the current functional component. When the comparison result is inconsistent, it may be determined that the target firmware update package is not for updating this functional component.

In another embodiment, determining the target component from the functional components of the first display device or the fourth display device based on the target firmware update package may include: when obtaining the target update instruction from the host device or the second display device, determining the target component from the functional components of the first display device or the fourth display device based on the identification information carried by the target update instruction, where the target update instruction at least includes an instruction for causing the first display device to obtain the target firmware update package.

The host device may be a PC device connected to the second display device via a USB or DP interface, and the target update instruction may be an update instruction pushed by the PC device. The target update instruction may be triggered by a user input on the PC device, or may be actively triggered and pushed by the PC device. For example, when the PC device receives a firmware update package pushed by the display device manufacturer, it may actively trigger the push of the target update instruction.

Alternatively, the host device may be regarded as a server of the display device manufacturer, the second display device may be connected to the server via wireless, and the server may push the target update instruction to the second display device via the wireless connection.

Alternatively, the target update instruction may be an instruction pushed by the second display device to the first display device based on a user operation. For example, the user may import a firmware update package in a mobile storage device into the second display device, and the second display device may push the target update instruction to the first display device.

The identification information carried by the target update instruction may be the identification information of the update object executed by the instruction, for example, the identification information may include the firmware name, model, etc. The target component, that is, the functional component that needs to update the firmware, may be determined based on the identification information.

In another embodiment, determining the target component from the functional components of the first display device or the fourth display device based on the target firmware update package, may include: obtaining the encryption information of the target firmware update package, and determining one component that matches the encryption information in the functional components of the first display device or the fourth display device as the target component.

It may be understood that different types of functional components in the first display device may have different encryption information, and the target firmware update package may also include encryption information. When updating the firmware update package, it may be first verified whether the encryption information of the firmware update package matches the encryption information of the firmware of one candidate component. When it matches, it may be determined that the candidate component is the target component that needs to be updated with firmware. When it does not match, it may be determined that the candidate component is not the target component. For example, when the target firmware update package is an update package encrypted using a first algorithm, the encryption algorithm configured by the USB HUB in the first display device may be a second algorithm, and the encryption algorithm configured by the PD controller may be a first algorithm. Therefore, when the target firmware update package is decrypted using the reverse algorithm of the second algorithm configured by the USB HUB, it may not be correctly decrypted, that is, the second algorithm and the first algorithm may not match and it may be determined that the USB HUB is not the target component. When the target firmware update package is decrypted using the reverse algorithm of the first algorithm configured by the PD controller, it may be correctly decrypted, and the PD controller may be determined as the target firmware.

In another embodiment, determining the target component from the functional components of the first display device or the fourth display device based on the target firmware update package, may include: obtaining the description information of the target firmware update package, and determining one component matching the description information in the functional components of the first display device or the fourth display device as the target component.

The description information may include a description of the functional aspects of the functional component to be updated. When the description information is used to adjust and update the display system, the target component may be determined to be the Scalar. When the description information is about power management control, the target component may be determined to be the PD Controller.

The above embodiments of determining the target component from the functional components of the first display device or the fourth display device based on the target firmware update package are used as examples to illustrate the present disclosure, but do not limit the manners for determining the target component.

In one embodiment, controlling, through the corresponding control circuit, the connection of the data transmission path between the video interface and the target component, may include: obtaining the component configuration information of the first display device, and generating a target control signal based on the component configuration information and the target firmware update package, such that the target control circuit responds to the target control signal to establish the data transmission path between the first functional component of the first display device and the target component, where the first functional component is a component connected to the video interface.

The component configuration information may include: which functional components the first display device includes, how many functional components there are, etc. On the premise of clarifying the component configuration information, combined with the information representing the uniqueness in the target firmware update package (such as component identification information), which functional component is the target component may be determined, and which control switches on which connection lines are required to turn on and/or off to achieve the creation of the data transmission path may be determined.

In the first display device, the line connection between different functional components may have multiple implementation modes, which may include direct line connection between different functional components, or connection between different functional components through at least one multiplexer controller. Only when corresponding multiplexer controllers control to connect specific switch/connection points, the communication path between two functional components may be realized.

There may be a multiplexer controller on the target control circuit, and the multiplexer controller on the target control circuit may need to execute the indicated action of the target control signal, control the turn-on or turn-off of the corresponding switches in the multiplexer controller, or control the connection or disconnection of the corresponding connection points, to establish the relevant data transmission path.

In one embodiment, controlling, through the corresponding control circuit, connection of the data transmission path between the video interface and the target component, may include: when the target component is the first functional component connected to the video interface, directly burning the target firmware update package into a first storage component connected to the first functional component by the first functional component.

In the application, the first functional component may be the Scalar or the USB HUB (the USB controller), and its flash memory area (the first storage component) may be directly mounted on its chip. The corresponding data of the target firmware update package may be directly burned into the flash memory area of the first functional component. Alternatively, the storage space in the Scalar or USB HUB chip may be used to first store the target firmware update package, and then the target firmware update package may be burned to the corresponding flash memory area to implement the firmware update.

FIG. 3 is a schematic diagram of the functional component connection lines of a first display device consistent with the present disclosure. The Scalar of the first display device and the USB HUB, and the USB HUB and the USB-C PD (PD Controller) are directly connected without passing through other multiplexer controllers. As shown in FIG. 3, for example, the Scalar receives the target firmware update package through the DP interface. When the target firmware update package is its own firmware update package, the Scalar may directly burn the target firmware update package into its own flash ROM area. When the Scalar chip receives the firmware update package of the USB HUB and the PD Controller, the Scalar may first burn the firmware update package into its own flash ROM area \textcircled{1} and area \textcircled{2} for temporary storage, and then the Scalar may send information through GPIO to notify the USB HUB that there is a new firmware that needs to be updated. The USB HUB may notify the Scalar through I2C to read the firmware update package of the USB HUB and the PD Controller. The Scalar may read the target firmware update package temporarily stored in area \textcircled{1} and area \textcircled{2} and put it into the RAM with a fixed address (pre-defined). The USB HUB may read the target firmware update package from the RAM through I2C, and burn its own firmware update package into its own flash ROM area \textcircled{3} and the firmware update package of the PD Controller into area \textcircled{4}. The USB HUB may transmit the firmware update package in area \textcircled{4} to the USB-C PD chip through I2C, and the PD chip may burn the firmware update package into area \textcircled{5} in its own flash ROM.

In another embodiment, controlling, through the corresponding control circuit, the connection of the data transmission path between the video interface and the target component, may include: when the target component is the first functional component connected to the video interface, controlling, through a first control circuit between the first functional component and a first storage component of the first functional component, connection of a first data transmission path between the first functional component and the first storage component, to burn the target firmware update package into the first storage component through the first data transmission path.

In some embodiments, the first functional component and the first storage component may not be directly connected, but may be connected through some other controllers, such as a multiplexer controller, to form a first control circuit. Therefore, when it is needed to burn the target firmware update package into the first storage component, it may be needed to control the first control circuit between the first functional component and the first storage component to connect the first data transmission path between the two, such that the target firmware update package is able to be transmitted and burned into the first storage component.

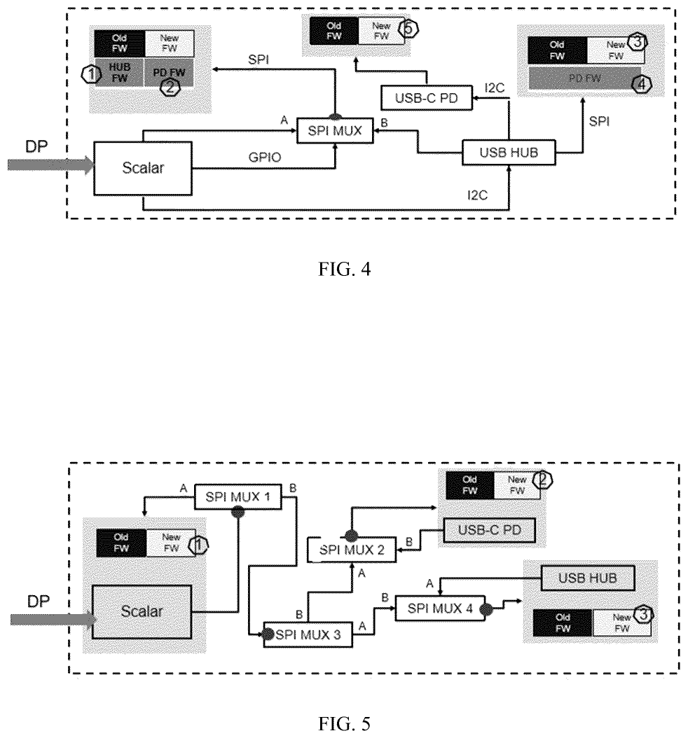

FIG. 4 is another schematic diagram of the functional component connection lines of a first display device consistent with the present disclosure. The Scalar and its first storage chip (the storage chip corresponding to the upper left corner) are connected via an SPI (Serial Peripheral Interface) MUX (multiplexer). When the SPI MUX is placed at the A end, the Scalar and the first storage chip (flash ROM) are connected. As shown in FIG. 4, for example, by default, the Scalar chip sets the SPI MUX to A through GPIO, that is, the Scalar and flash are connected, and the Scalar receives its own firmware update package and directly burns it into its own flash ROM. After the Scalar chip receives the firmware update package of the USB HUB and PD Controller, it may first burn the firmware update package into its own flash ROM for temporary storage in area \textcircled{1} and area \textcircled{2}. The Scalar chip may set the SPI MUX to B through GPIO, that is, the USB HUB and the flash ROM of the Scalar are connected. Synchronously, the Scalar may notify the USB HUB through I2C that there is a new firmware update package that needs to be obtained, and the USB HUB may directly read the firmware update package of the USB HUB and PD Controller in area \textcircled{1} and area \textcircled{2} through the path between the USB HUB and the Scalar's flash ROM. The firmware update package belonging to the USB HUB itself may be directly burned into its own flash ROM area \textcircled{3}, and the firmware update package belonging to the PD Controller may be burned into area \textcircled{4}. The USB HUB may transmit the firmware update package in area \textcircled{4} to the USB-C PD chip through I2C, and the PD chip may burn the firmware update package into its own flash Area \textcircled{5} in ROM.

In another embodiment, controlling, through the corresponding control circuit, the connection of the data transmission path between the video interface and the target component, may include: when the target component is a second functional component of the first display device, controlling, through a second control circuit between the first functional component and the second functional component, connection of a second data transmission path between the first functional component and the second functional component, to transmit the target firmware update package to the second functional component through the second data transmission path.

As shown in FIG. 4, in one embodiment, the Scalar may be understood as the first functional component, the USB HUB may be understood as the second functional component, the line between the two functional components may also include SPI MUX, and the line including SPI MUX between the two functional components may be understood as the second control circuit. The transmission of the target firmware update package between the two components may be seen in the above-mentioned specific example content introduction about FIG. 4, which will not be repeated here.

In some other examples, the Scalar may be the first functional component and the PD Controller may be the second functional component. Therefore, the Scalar and the PD Controller may be connected through a multiplexer controller. The data path between the Scalar and the PD Controller may be turned on by controlling the switch or selecting the connection points by the multiplexer controller. In one embodiment shown in FIG. 5, which is another schematic diagram of the functional component connection lines of a first display device consistent with the present disclosure, the Scalar and the PD Controller are connected through three multiplexer controllers, and the three multiplexer controllers are distributed along the line in order of SPI MUX1, SPI MUX3 and SPI MUX2. As shown in FIG. 5, in one embodiment, by default, the Scalar chip sets SPI MUX 1 to A through GPIO, that is, scalar and flash are connected; the Scalar chip receives its own firmware update package and directly burns it into area \textcircled{1} in its own flash ROM. After the Scalar chip receives the firmware update package of the PD Controller, it sets MUX 1 to B, MUX 3 to B, and MUX 2 to A through GPIO, and the scalar is connected to the flash ROM of the PD Controller, and the firmware update package of the PD Controller is burned into area \textcircled{2}. After the burning is completed, MUX 2 is set to B, and the normal use of the PD is restored. After the Scalar chip receives the firmware update package of the USB HUB, it sets MUX 1 to B, MUX 3 to A, and MUX 4 to B through GPIO, and the scalar is connected to the flash ROM of the USB HUB, such that the firmware update package of the USB HUB is burned into area \textcircled{3}. After the burning is completed, MUX 4 is set to A, and the normal use of the USB HUB is restored.

In another embodiment, controlling, through the corresponding control circuit, the connection of the data transmission path between the video interface and the target component, may include: when the target component is a third functional component of the first display device or the fourth display device, controlling, through the second control circuit between the first functional component and the second functional component and a third control circuit between the second functional component and the third functional component, connection of a third data transmission path between the first functional component and the third functional component, to transmit the target firmware update package to the third functional component through the third data transmission path.

In this embodiment, the first functional component may be the Scalar, the second functional component may be the USB HUB, and the third functional component may be the PD Controller. As shown in FIG. 3 or FIG. 4, there may be no connection line between the Scalar and the PD Controller, and the firmware update package of the PD Controller may only be transmitted to the USB HUB first and then forwarded to the PD Controller by the USB HUB. The third data transmission path between the Scalar and the PD Controller may be understood in combination with the corresponding example introduction of FIG. 3 or FIG. 4. Of course, in some other embodiments, in addition to the PD Controller of the first display device, the third functional component may also be the scalar or USB HUB of the fourth display device. In this way, the data transmission path between the first functional component of the first display device and the third functional component in the fourth display device may also need to be forwarded through the second functional component of the first display device.

The above embodiments illustrate several different implementations of controlling the connection of the data transmission path between the video interface and the target component through the corresponding control circuit, which is convenient for those skilled in the art to better understand and implement the technical solution of the present disclosure.

In some embodiments, when the target component is not the first functional component connected to the video interface, controlling the target component to complete the firmware update operation based on the target path, may include: storing the target firmware update package in the first storage component of the first functional component, and burning the target firmware update package to the target component through the target path based on the interactive signal between the first functional component and the target component.

As shown in FIG. 3 and FIG. 4, in one embodiment, the target firmware update package stored in the flash ROM (the first storage component) of the Scalar may be transmitted to the USB HUB through the interactive signal between the Scalar and the USB HUB by that: the Scalar indicates that the USB HUB has a new firmware update package through the GPIO signal, and the USB HUB indicates that the Scalar needs to read the firmware update packages of the USB HUB and the PD Controller through the I2C signal, and then the target firmware update package is transmitted from the Scalar to the USB HUB.

In some other embodiment, when the target component is not the first functional component connected to the video interface, controlling the target component to complete the firmware update operation based on the target path, may include: directly transmitting the target firmware update package to the target component based on the target path, such that it completes the firmware update operation.

As shown in FIG. 5, the first functional component is the Scalar, and there is a data path between the Scalar and USB HUB, and a data path between the Scalar and PD Controller. Therefore, when the USB HUB or PD Controller is the target firmware, the data transmission path from the Scalar to the USB HUB or PD Controller may be directly established without forwarding by other functional components, such that the target firmware update package is able to be directly transmitted.

In some other embodiments, the firmware update method may further include: obtaining the operation state of the target component, and storing the target firmware update package in the first storage component of the first functional component or in the second storage component of the second functional component of the first display device based on the operation state, where the second functional component may belong to or not belong to the target component.

It may be understood that, in actual applications, the target component of the first display device may be in a working state. At this time, is the target firmware update package is burned, the normal operation of the display device may be interrupted, affecting the user's experience. Therefore, in this embodiment, after the target firmware update package is obtained, when it is determined that the target component is in the working state, the target firmware update package may be first stored in the flash memory area of the first functional component or the flash memory area of the second functional component, and after the target component stops working, the target firmware update package may be controlled to be burned to the storage area corresponding to the target component.

For example, after the Scalar obtains the target firmware update package through the DP interface, it may be determined that the corresponding target component is the USB HUB. When the USB HUB is in the working state presently, the target firmware update package may be stored in the flash memory of the Scalar first. After the USB HUB stops working, the target firmware update package may be obtained from the Scalar and burned to the storage area of the USB HUB. Or, in another embodiment, the target firmware update package may be transmitted to the USB HUB and stored in the flash memory of the USB HUB without being burned directly. After the USB HUB stops working, the target firmware update package in the flash memory area may be burned.

In the above embodiments, it may be ensured that the firmware update of the display device does not affect the normal operation of the display device, and the silent firmware update may be realized. That is, the firmware update may be completed when the normal operation of the display device is not affected and the user may not be aware of it, which may not affect the user's experience.

In some other embodiments, the firmware update method may further include: after the target component completes the corresponding firmware update operation, restoring the target path to the default signal path between the functional components of the first display device; and after the target component completes the corresponding firmware update operation, clearing the target firmware update package from the storage component where it is located or transferring the target firmware update package to a backup storage area.

As shown in FIG. 4 or FIG. 5, different functional components of the first display device are connected through at least one multiplexer controller (SPI MUX). When the target firmware update package needs to be transmitted, the data transmission path connected by these multiplexer controllers may change to realize the transmission of the target firmware update package to the target component. In this embodiment, after the target component completes the corresponding firmware update operation, the target path (the data path for transmitting the target firmware update package) may be restored to the default signal path under the normal working condition of the first display device, such that the first display device may continue to work normally.

In one embodiment shown in FIG. 4, the SPI MUX is connected to the A end by default, and the Scalar is directly connected to its flash memory. Only when the target firmware update package needs to be transmitted to the USB HUB, the SPI MUX may be connected to the B end, and the target firmware update package in the Scalar flash memory area may be transmitted to the USB HUB. After the USB HUB receives the target firmware update package, the SPI MUX may be restored to the default connection to the A end, such that the Scalar is connected to its flash memory.

In the firmware update method described in the above embodiments, the target path to transmit the target firmware update package may be controlled to be connected when the firmware update is required. After the target firmware update package is transmitted, the original default signal path may be restored, such that the first display device continues to work without affecting the normal use of the user.

For the aforementioned method embodiments, for the sake of simple description, they are all expressed as a series of action combinations, but those skilled in the art should know that the present disclosure is not limited to the described action sequence. According to the present disclosure, some steps can be performed in other sequences or simultaneously. Those skilled in the art should also know that the embodiments described in the present disclosure are merely examples, and the actions and modules involved are not necessarily required by the present disclosure.

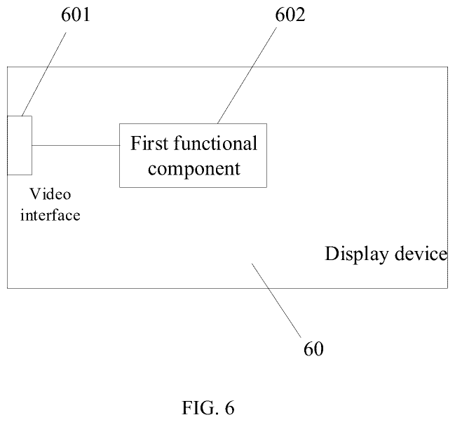

The present disclosure also provides a display device. In one embodiment, as shown in FIG. 6, which is a schematic structural diagram of a display device consistent with the present disclosure, the display device may be understood as the first display device described in the aforementioned embodiments, and, the display device 60 may include a video interface 601 and a first functional component 602.

The video interface 601 may be used to be connected in series to a second display device to obtain, through the second display device, a target firmware update package provided by the host device.

The video interface may be, but is not limited to, a DP interface, an HDMI interface, a VGA interface, a DVI interface, etc. The first display device and the second display device may be any two display devices connected in series in a daisy-chain display device combination.

The first functional component 602 may be connected to the video interface and may establish a target path to a target component based on the target firmware update package, to enable the target component to complete the firmware update operation based on the target path.

The target component may belong to or not belong to the first display device. The firmware update data of any display device in the daisy-chain display device combination may be forwarded by other display devices connected in series to it, such the target component corresponding to the target firmware update package may be a functional component of the first display device itself, or a functional component of other display devices connected downstream of the first display device.

The second display device may be directly connected in series to the host device through a first interface, and the first interface may be the same as or different from the video interface; or, the second display device may be connected in series to the host device through at least one third display device.

The display device described in this embodiment may be a display device in a daisy chain display device combination. According to this display device, when the firmware of multiple display devices in the daisy chain display device combination is updated, it may not be needed to establish a data transmission path for each display device and send a firmware update package. The firmware update packages of all display devices may be transmitted by the host device through the video interface between each display device in the daisy chain, and each display device may establish a target path between the target component based on the target firmware update package to transmit the target firmware update package, such that the target component completes the firmware update. The firmware update of the daisy chain display device combination may be simple and efficient, and the firmware update may be completed without the user's manual participation, thereby improving the user experience.

In some embodiments, the display device may also include: a control circuit, which is arranged between the first functional component and other functional components of the first display device.

The control circuit may establish different communication paths under different control states. For example, the control circuit may include an SPI MUX. When the SPI MUX is connected to the A end, the Scalar may be connected to its flash memory. When the SPI MUX is connected to the B end, the flash memory of the Scalar may be connected to the USB HUB.

In some embodiments, the first functional component may also determine the target component from the other functional components based on the target firmware update package.

Before the first functional component establishes the target path with the target component based on the target firmware update package, it may need to first determine the target component. In this embodiment, the target component may be determined based on the attribute information of the target firmware update package. The attribute information may include but is not limited to attribute identification, attribute description information, encryption information, etc.

The control circuit may respond to the target signal sent by the first functional component and/or the target component to establish the data transmission path between the first functional component and the target component, to transmit the target firmware update package to the target component through the data transmission path.

The target signal may include, for example, a GPIO signal, an I2C signal, etc. As shown in FIG. 3, after the Scalar chip receives the firmware update package of the USB HUB and the PD Controller, it determines that the target component is the USB HUB. First, the SPI MUX is set to A through GPIO, that is, the scalar is connected to the flash, and the target firmware update package is first burned into its own flash ROM for temporary storage in areas \textcircled{1} and \textcircled{2}. The Scalar chip sets the SPI MUX to B through GPIO, that is, the USB HUB is connected to the flash ROM of the Scalar chip. At this time, the USB HUB learns that there is a new firmware update package, and the USB HUB directly reads the firmware update package of the USB HUB and the PD Controller in areas \textcircled{1} and \textcircled{2}. Thus, the control circuit including the multi-channel controller establishes a data transmission path between the first functional component and the target component in response to the target signal sent by the first functional component and/or the target component.

The above embodiments illustrate the specific implementation content of the first functional component determining the target component and establishing the target path for transmitting the target firmware update package, such that technicians in the field can better understand and implement the technical solution disclosed in the present disclosure.

For the details of the above electronic device and its various structures, references may be made to the content introduction of the corresponding part in the method embodiments, and will not be repeated here.

Any of the display devices described in the above embodiments may include a processor and a memory. The operations that are able to be performed by the first functional component of the display device in the above embodiments may be stored in the memory as a program module, and the processor may execute the above program module stored in the memory to implement the corresponding function.

The processor may include kernels, and the kernels may retrieve the corresponding program module from the memory. One or more kernels may be set to achieve the processing of the revisited data by adjusting the kernel parameters.

The memory may include a non-permanent memory in a computer-readable medium, a random access memory (RAM) and/or a non-volatile memory, such as a read-only memory (ROM) or a flash RAM, and the memory may include at least one memory chip.

The present disclosure also provides a computer-readable storage medium. The computer-readable storage medium may be configured to store a computer program, which may be directly loaded into the internal memory of a computer and may include software codes. The computer program may implement steps of any firmware update method provided by various embodiments of the present disclosure after being loaded and executed by the computer.

The present disclosure also provides a computer program product, which may be directly loaded into an internal memory of a computer and may include software codes. The computer program may implement steps of any firmware update method provided by various embodiments of the present disclosure after being loaded and executed by the computer.

In the present disclosure, each embodiment is described in a progressive manner, and each embodiment focuses on the differences from other embodiments. Same and similar parts between the embodiments may be referred to each other. For the apparatus disclosed in the embodiments, since it corresponds to the method disclosed in the embodiments, the description is relatively simple, and the relevant parts may be referred to the description of the method embodiments.

In the present disclosure, relational terms such as first and second are only used to distinguish one entity or operation from another entity or operation, and do not necessarily require or imply that there is any such actual relationship or order between these entities or operations. Moreover, the terms “include,” “comprise” or any other variant thereof are intended to cover non-exclusive inclusion, such that the process, method, article or device including a series of elements includes not only those elements, but also other elements not explicitly listed, or also includes elements inherent to such process, method, article or device. In the absence of more restrictions, the elements associated with the phrase “including one . . . ” do not exclude the existence of other identical elements in the process, method, article or device including the elements.

The steps of the method or algorithm described in conjunction with the embodiments of the present disclosure may be directly implemented using hardware, software modules executed by a processor, or a combination of the two. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the scope of the present disclosure is not limited to the embodiments shown herein, but conforms to the broadest scope consistent with the principles and novel features disclosed herein.

What is claimed is:

1. A firmware update method comprising:
in response to obtaining, by a first display device through a video interface with a second display device, a target firmware update package provided by a host device, establishing a target path to a target component based on the target firmware update package, to enable the target component to complete a firmware update operation based on the target path;
wherein:
the second display device is directly connected in series to the host device through the video interface or through an interface other than the video interface; or
the second display device is connected in series to the host device through at least one third display device.

2. The method according to claim 1, wherein establishing the target path includes:
determining the target component from functional components of the first display device or a fourth display device based on the target firmware update package, the fourth display device being connected in series to the first display device; and
controlling, through a corresponding control circuit, connection of a data transmission path between the video interface and the target component.

3. The method according to claim 2, wherein determining the target component from the functional components includes at least one of:
obtaining attribute information of the target firmware update package, and determining one of the functional components that matches the attribute information as the target component;
obtaining a target update instruction from the host device or the second display device, and determining the target component from the functional components based on identification information carried by the target update instruction, the target update instruction at least including an instruction enabling the first display device to obtain the target firmware update package;
obtaining encryption information of the target firmware update package, and determining one of the functional components that matches the encryption information as the target component; or
obtaining description information of the target firmware update package, and determining one of the functional components that matches the description information as the target component.

4. The method according to claim 2, wherein controlling the connection of the data transmission path includes:
obtaining component configuration information of the first display device; and
generating a target control signal based on the component configuration information and the target firmware update package, to enable the target control circuit to establish a data transmission path between one functional component of the first display device and the target component in response to the target control signal, the one functional component being connected to the video interface.

5. The method according to claim 2, wherein:
the target component is one functional component connected to the video interface; and
controlling the connection of the data transmission path includes:
directly burning, by the one functional component, the target firmware update package into a storage component connected to the one functional component.

6. The method according to claim 2, wherein:
the target component is one functional component connected to the video interface; and
controlling the connection of the data transmission path includes:
controlling, through a control circuit between the one functional component and a storage component of the one functional component, connection of a data transmission path between the one functional component and the storage component, to enable the target firmware update package to be burned into the storage component through the data transmission path between the one function al component and the storage component.

7. The method according to claim 2, wherein:
the first display device includes a first functional component connected to the video interface;
the target component is a second functional component of the first display device; and
controlling the connection of the data transmission path includes:
controlling, through a control circuit between the first functional component and the second functional component, connection of a data transmission path between the first functional component and the second functional component, to enable the target firmware update package to be transmitted to the second functional component through the data transmission path between the first functional component and the second functional component.

8. The method according to claim 2, wherein:
the first display device includes a first functional component connected to the video interface and a second functional component;
the target component is a third functional component of the first display device or the fourth display device; and
controlling the connection of the data transmission path includes:
controlling, through a control circuit between the first functional component and the second functional component and a control circuit between the second functional component and the third functional component, connection of a data transmission path between the first functional component and the third functional component, to enable the target firmware update package to be transmitted to the third functional component through the data transmission path between the first functional component and the third functional component.

9. The method according to claim 1, wherein enabling the target component to complete the firmware update operation based on the target path includes at least one of:
storing the target firmware update package in a storage component of a functional component connected to the video interface, and burning the target firmware update package to the target component through the target path based on an interaction signal between the functional component and the target component; or
transmitting the target firmware update package directly to the target component based on the target path, to enable the target component to complete the firmware update operation.

10. The method according to claim 9,
wherein the functional component is a first functional component, and the storage component is a first storage component;
the method further comprising:
obtaining an operation state of the target component; and
storing, based on the operation state, the target firmware update package in the first storage component or in a second storage component of a second functional component of the first display device.

11. The method according to claim 1, further comprising at least one of, after the target component completes the firmware update operation:
restoring the target path to a default signal path between functional components of the first display device; or
clearing the target firmware update package from a storage component storing the target firmware update package or transferring the target firmware update package to a backup storage area.

12. A first display device comprising:
a video interface, configured to be connected in series to a second display device to obtain, through the second display device, a target firmware update package provided by a host device; and
a functional component, connected to the video interface and configured to establish a target path to a target component based on the target firmware update package, to enable the target component to complete a firmware update operation based on the target path;
wherein:
the second display device is directly connected in series to the host device through the video interface or through an interface other than the video interface; or
the second display device is connected in series to the host device through at least one third display device.

13. The first display device according to claim 12, further comprising:
a control circuit arranged between the functional component and other functional components of the first display device;
wherein:
the functional component is further configured to determine the target component from the other functional components based on the target firmware update package; and
the control circuit is configured to establish a data transmission path between the functional component and the target component in response to a target signal sent by at least one of the functional component or the target component, to transmit the target firmware update package to the target component through the data transmission path.

14. The first display device according to claim 12, further comprising:
a control circuit;
wherein:
the functional component is further configured to determine the target component from other functional components of the first display device or a fourth display device based on the target firmware update package, the fourth display device being connected in series to the first display device; and
the control circuit is configured to establish a data transmission path between the video interface and the target component.

15. The first display device according to claim 14, wherein the target component is determined from the other functional components by at least one of:
obtaining attribute information of the target firmware update package, and determining one of the other functional components that matches the attribute information as the target component;
obtaining a target update instruction from the host device or the second display device, and determining the target component from the other functional components based on identification information carried by the target update instruction, the target update instruction at least including an instruction enabling the first display device to obtain the target firmware update package;
obtaining encryption information of the target firmware update package, and determining one of the other functional components that matches the encryption information as the target component; or
obtaining description information of the target firmware update package, and determining one of the other functional components that matches the description information as the target component.

16. The first display device according to claim 14, wherein the control circuit is configured to:
establish a data transmission path between the functional component and the target component in response to a target control signal generated based on component configuration information of the first display device and the target firmware update package.

17. The first display device according to claim 14, wherein:
the target component is the functional component; and
the functional component is configured to:
directly burn the target firmware update package into a storage component connected to the functional component.

18. The first display device according to claim 14, wherein:
the target component is the functional component; and
the control circuit is between the functional component and a storage component of the functional component, and is configured to:
control connection of a data transmission path between the functional component and the storage component, to enable the target firmware update package to be burned into the storage component through the data transmission path between the function al component and the storage component.

19. The first display device according to claim 14, wherein:
the function component is a first functional component;
the target component is a second functional component of the first display device; and
the control circuit is between the first functional component and the second functional component, and is configured to:
control connection of a data transmission path between the first functional component and the second functional component, to enable the target firmware update package to be transmitted to the second functional component through the data transmission path between the first functional component and the second functional component.

20. The first display device according to claim 14, wherein:
the functional component is a first functional component, and the first display device further includes a second functional component;
the target component is a third functional component of the first display device or the fourth display device; and
the control circuit is a first control circuit between the first functional component and the second functional component, and is configured to, together with a second control circuit between the second functional component and the third functional component:
control connection of a data transmission path between the first functional component and the third functional component, to enable the target firmware update package to be transmitted to the third functional component through the data transmission path between the first functional component and the third functional component.
